(19) United States
(12) Patent Application Publication
(10) Pub. No.: US 2023/0226515 A1
(43) Pub. Date: Jul. 20, 2023

(54) INTEGRATED CARBON TRANSFORMATION REFORMER AND PROCESSES

(71) Applicant: RECARBON, INC., Santa Clara, CA (US)

(72) Inventors: Hatem Harraz, Berkeley, CA (US); Jae Mo Koo, Palo Alto, CA (US)

(21) Appl. No.: 18/154,779

(22) Filed: Jan. 13, 2023

Related U.S. Application Data
(60) Provisional application No. 63/266,827, filed on Jan. 14, 2022.

(51) Int. Cl. B01J 19/24; B01J 19/00; B01J 19/08; C01B 3/26; C01B 3/38

(52) U.S. Cl. CPC B01J 19/245; B01J 19/0013; B01J 19/088; C01B 3/26; C01B 3/382; B01J 2219/00092; B01J 2219/0869; B01J 2219/0871; B01J 2219/0894; C01B 2203/0233; C01B 2203/0238; C01B 2203/0277; C01B 2203/0883; C01B 2203/1241

(57) ABSTRACT

An integrated reformer includes an outer chamber, a first inlet, a second inlet, and a cooling unit associated with the outer chamber. The first inlet is configured to obtain a first gas stream into a first space in the outer chamber. The second inlet is configured to obtain a second gas stream into the first space in the outer chamber. The cooling unit is configured to absorb thermal energy from the first gas stream.

### CROSS REFERENCE TO RELATED APPLICATIONS

This U.S. Pat. Application claims priority to Provisional Patent Application 63/266,827 filed on Jan. 14, 2022. The disclosure of this prior application is considered part of the disclosure of this application and is hereby incorporated by reference in its entirety.

### TECHNICAL FIELD

This disclosure generally relates to an integrated carbon transformation reformer and processes including CO₂ reduction processes.

### BACKGROUND

Unless otherwise indicated herein, the materials described herein are not prior art to the claims in the present application and are not admitted to be prior art by inclusion in this section.

Plasma-based dissociation reactions may be used to facilitate carbon-based chemical reactions. The plasma-based dissociation reactions may provide high temperature and energy to drive completion of the carbon-based chemical reactions.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

One aspect of the disclosure provides a device (such as an integrated reformer). The device includes an outer chamber, a first inlet configured to obtain a first gas stream into a first space in the outer chamber, a second inlet configured to obtain a second gas stream into the first space in the outer chamber, and a cooling unit associated with the outer chamber. The cooling unit is configured to absorb thermal energy from the first gas stream.

Implementations of the disclosure may include one or more of the following optional features. In some implementations, the cooling unit is disposed adjacent to the first inlet. In some implementations, the cooling unit includes a tube disposed around the outer chamber. In some implementations, the tube includes a coolant inlet configured to receive coolant, and the tube includes a coolant outlet configured to output the coolant that absorbed at least some of the thermal energy from the first gas stream. In some implementations, the coolant received by the coolant inlet includes H₂O in a liquid state, and the coolant from the coolant outlet includes H₂O in a gas state.

In some implementations, the device includes a reaction chamber in the outer chamber. In some implementations, the coolant from the coolant outlet, the first gas stream, and the second gas stream are provided to a second space in the reaction chamber. In some implementations, the device includes a catalyst in the reaction chamber. In some implementations, the coolant from the coolant outlet, the first gas stream, and the second gas stream pass through the catalyst. In some implementations, the catalyst includes a porous material. In some implementations, the device includes an outlet configured to output a third gas stream from the reaction chamber. In some implementations, the third gas stream is based on reactions occurred with the first gas stream, the second gas stream, and the coolant from the coolant outlet. In some implementations, the first gas stream includes first synthesis gas, the second gas stream includes hydrocarbon fuel (e.g., biogas, natural gas, CH₄, or any combinations thereof), and the third gas stream includes third synthesis gas.

In some implementations, the coolant from the coolant outlet is provided to the first space in the outer chamber. In some implementations, the device includes an outlet and a catalyst between the first inlet and the outlet. In some implementations, the outlet outputs a third gas stream based on reactions occurred with the first gas stream, the second gas stream, and the coolant from the coolant outlet. In some implementations, the catalyst includes a porous material. In some implementations, the first gas stream includes first synthesis gas, the second gas stream includes hydrocarbon fuel (e.g., biogas, natural gas, CH₄, or any combinations thereof), and the third gas stream includes second synthesis gas.

Another aspect of the disclosure provides a system. The system includes a plasma carbon conversion unit including a plasma reactor and an integrated reformer in fluid communication with the plasma reactor. The integrated reformer includes an outer chamber, a first inlet configured to obtain a first gas stream from the plasma reactor into a first space in the outer chamber, a second inlet configured to obtain a second gas stream into the first space in the outer chamber, and a cooling unit associated with the outer chamber. The cooling unit is configured to absorb thermal energy from the first gas stream.

Implementations of the disclosure may include one or more of the following optional features. In some implementations, the cooling unit is disposed adjacent to the first inlet. In some implementations, the cooling unit includes a tube disposed around the outer chamber. In some implementations, the tube includes a coolant inlet configured to receive coolant, and the tube includes a coolant outlet configured to output the coolant that absorbed the thermal energy from the first gas stream. In some implementations, the system includes an outlet configured to output a third gas stream from the integrated reformer. In some implementations, the third gas stream is based on reactions occurred with the first gas stream, the second gas stream, and the coolant from the coolant outlet. In some implementations, the system includes a heat utilization unit in fluid communication with the outlet. In some implementations, the heat utilization unit is configured to receive the third gas stream and configured to cool down the third gas stream to a predetermined temperature suitable for an additional process or downstream process (e.g., water-gas shift process). In some implementations, the predetermined temperature for downstream water-gas shift process is between 300° C. and 350° C.

### DESCRIPTION OF DRAWINGS

Example implementations will be described and explained with additional specificity and detail through the use of the accompanying drawings in which:

FIG. 1 illustrates an example operation of a plasma carbon conversion unit (PCCU) in accordance with some implementation of this disclosure.

FIG. 2 illustrates an example carbon dioxide (CO₂) reduction and utilization system in accordance with some implementations of this disclosure;

FIG. 3 illustrates another example CO₂ reduction and utilization system in accordance with some implementations of this disclosure;

FIG. 4 illustrates another example CO₂ reduction and utilization system in accordance with some implementations of this disclosure;

FIG. 5A illustrates a cross-sectional view of an example integrated reformer in accordance with some implementations of this disclosure;

FIG. 5B illustrates a cross-sectional view of an example integrated reformer in accordance with some implementations of this disclosure;

FIG. 6A illustrates a cross-sectional view of another example integrated reformer in accordance with some implementations of this disclosure; and

FIG. 6B illustrates a cross-sectional view of another example integrated reformer in accordance with some implementations of this disclosure.

FIG. 7 illustrates a flowchart for an example method for plasma carbon conversion unit in accordance with some implementation of this disclosure.

Like reference symbols in the various drawings indicate like elements.

### DETAILED DESCRIPTION

In some implementations, chemical reactions (e.g., exothermic reaction) performed using a plasma carbon conversion unit (PCCU) provides a high temperature reaction environment that drives or promotes the chemical reactions to completion. This disclosure may relate to, among other things, chemical reactions for removing carbon dioxide (CO₂) (e.g., reducing CO₂ output) and/or generating various product gases, such as hydrogen gas (H₂), carbon monoxide (CO), and synthesis gas (e.g., gas including H₂ and CO) using the PCCU.

In some implementations, the PCCU includes a plasma reactor and an integrated reformer in fluid communication with the plasma reactor. The chemical reactions performed using the plasma reactor may provide greater yields of the product gases because the plasma reactor provides a great amount of energy for driving the formation of the product gases (e.g., synthesis gas).

In some implementations, energy (e.g., kinetic energy, thermal energy) generated from operation of the plasma reactor drives further operations of other processing units and/or chemical reactions. For example, the energy from the plasma reactor may be used to drive operations of the integrated reformer, heat utilization unit(s) associated with the integrated reformer, and/or any other processes of the formation, recycling, and separation of various product gases.

In some implementations, the plasma reactor converts CO₂ and CH₄ in a first input source into first synthesis gas using microwave plasma (e.g., exposing the first input source with microwave plasma (e.g., atmospheric microwave plasma, high-pressure microwave plasma)). In some implementations, the integrated reformer, in fluid communication with the plasma reactor, receives the first synthesis gas from the plasma reactor, mixes the first synthesis gas with hydrocarbon fuel such as biogas (e.g., scrubbed biogas including CO₂ and CH₄), CH₄, natural gas, or any combinations thereof, and converts the mixtures of the first synthesis gas and the hydrocarbon fuel into second synthesis gas using a steam reforming process. In some implementations, to conserve energy, the energy from the plasma reactor is utilized for the steam reforming process. As a result, the integrated reformer converts CO₂, CH₄, H₂, CO, and H₂O in a second input source (a mixture of the first synthesis, hydrocarbon fuel, and steam) into the second synthesis gas using the energy (generated from chemical reactions at the plasma reactor). Using the plasma reactor and the integrated reformer, the PCCU is capable of producing a greater amount of synthesis gas using the energy from the plasma reactor (without having additional energy source for processes including the steam reforming process).

The present disclosure includes several systems that are arranged with various types of equipment (e.g., heat utilization unit, water-gas shift reactor, amine unit, pressure swing adsorption unit, compressor, pre-compressor, air separator, separator unit) along with the PCCU for converting various gases (e.g., biogas, natural gas/methane (e.g., gas including CH4), CO₂, various combination thereof) into synthesis gas (e.g., second synthesis gas described above) and transforming the synthesis gas into various end products (e.g., synthesis gas with various H₂:CO ratios, H₂).

In some implementations, a heat utilization unit, associated with the integrated reformer (or the PCCU), is configured to adjust the temperature of the second synthesis gas. For example, the heat utilization unit absorbs the thermal energy from the second synthesis gas. As a result, the heat utilization unit cools down the second synthesis gas so that the second synthesis gas is suitable for subsequence processes performed by various pieces of equipment (e.g., water-gas shift reactor, amine unit, pressure swing adsorption unit, compressor). In some implementations, the heat utilization unit provides a coolant, which may include steam (e.g., water vapor, superheated water) to the integrated reformer and/or the water-gas shift reactor using the thermal energy absorbed from the second synthesis gas. In some implementations, the heat utilization unit heats or preheats feed (e.g., hydrocarbon fuel, steam for the steam reforming process) to the integrated reformer. In some implementations, the heat utilization unit provides power to various pieces of equipment (e.g., compressor, pre-compressor) by converting the thermal energy from the integrated reformer to electrical power using a suitable method (e.g., generating steam using the thermal energy to operate a steam turbine).

In some implementations, the water-gas shift reactor facilitates formation of H₂ via a water-gas shift reactor in which carbon monoxide and water reversibly react to form CO₂ and H₂. For example, the water-gas shift reactor converts CO and H₂O in the second synthesis gas going through the water-gas shift reactor into H₂ and CO₂ (e.g., converting CO to H₂).

In some implementations, the amine unit is configured to capture or remove CO₂ from process gas (e.g., second synthesis gas, gas including H₂ and CO₂ generated by the water-gas shift reactor based on the second synthesis gas) input to the amine unit.

In some implementations, the pressure swing adsorption unit is configured to capture or remove CO and impurities from process gas (e.g., gas including H₂ and CO generated by the water-gas shift reactor and the amine unit) input to the pressure swing adsorption unit.

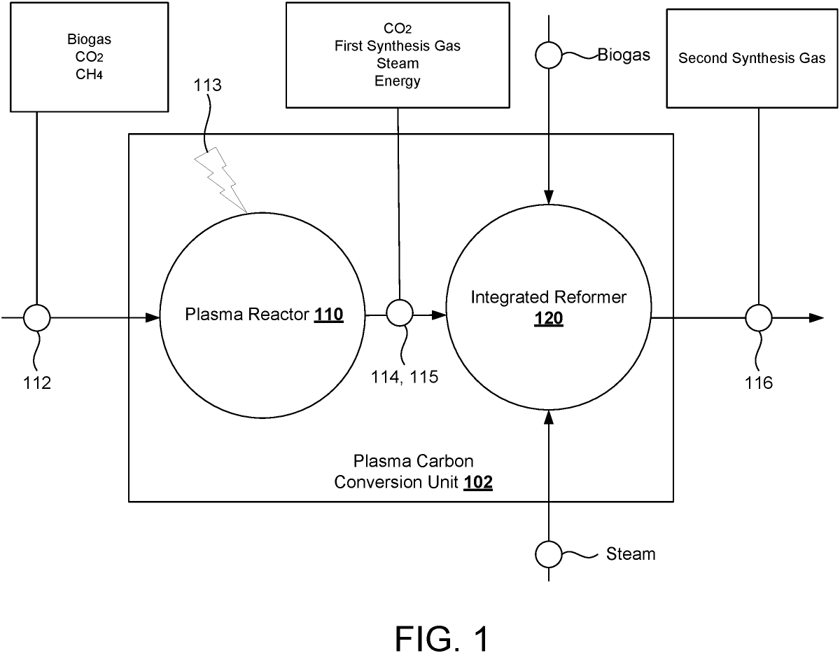

FIG. 1 illustrates an example operation of a PCCU 102 in accordance with some implementation of this disclosure.

As shown in FIG. 1, in some implementations, the PCCU 102 includes a plasma reactor 110 and an integrated reformer 120 in fluid communication with the plasma reactor 110. The fluid communication between the plasma reactor 110 and the integrated reformer 120 is operated to support an output stream 114 (including first synthesis gas generated or converted by the plasma reactor 110) to the integrated reformer 120.

As shown, in some implementations, the plasma reactor 110 obtains an input stream 112 of biogas (e.g., gas including CH₄ and CO₂), carbon dioxide (CO₂), oxygen (O₂), and natural gas/methane (CH₄) along with input energy 113 (e.g., microwave energy) and generates or yields the output stream 114 of carbon dioxide (CO₂) gas, steam, and the first synthesis gas (gas including H₂ and CO). As a result, the reactions between the input stream 112 and the input energy (microwave energy as discussed above) create plasma (e.g., microwave plasma) that converts the input stream 112 into the output stream 114 (including the first synthesis gas).

As shown, in some implementations, the reactions between the input stream 112 and the input energy 113, generate output energy 115 (e.g., kinetic energy, thermal energy) at the plasma reactor 110, and the output energy 115 is transferred to the integrated reformer 120 via the output stream 114. As a result, the temperature of output stream 114 is high (e.g., temperature greater than 1500° C. in this example). In some implementations, the reactions between the input steam 112 and the input energy 113 at the plasma reactor 110 generate kinetic energy.

In some implementations, the biogas, CO₂, and natural gas/methane react in response to energy provided to the plasma reactor 110 and yield the first synthesis gas, steam, and a leftover amount of carbon dioxide as chemical products. As a result, a substantial amount of the carbon dioxide included in the input stream 112 is removed. Furthermore, power may be generated by the chemical reactions that yielded the first synthesis gas such that the chemical products are output at a high temperature (e.g., 1,000° C., 1,100° C., 1,200° C., 1,300° C., 1,400° C., 1,500° C., 1,600° C., 1,700° C., 1,800° C., 1,900° C., 2,000° C., etc.). As discussed above, in this example, the first synthesis gas from the plasma reactor 110 has a temperature greater than 1500° C.

As shown in FIG. 1, in some implementations, the amount of carbon dioxide included in the input stream 112 to the plasma reactor 110 is greater than the amount of carbon dioxide included in the output stream 114. In some implementations, the input energy 113 is less than the output energy 115 yielded by the plasma reactor 110 because the chemical reactions affected in the plasma reactor 110 is exothermic reactions that generate thermal energy (e.g., heat) during the reaction process. In some implementations, the energy generated by the chemical reactions and/or the carbon dioxide yielded by the chemical reactions in the plasma reactor 110 may be recycled and included in as inputs to the PCCU 100 (e.g., plasma reactor 110, integrated reformer 120) to facilitate further chemical reactions and/or reduction of carbon dioxide (CO₂).

As shown, in some implementations, the integrated reformer 120 obtains the output stream 114 (including the CO₂ gas, steam, first synthesis gas) and mixes the output stream 114 with additional hydrocarbon fuel (e.g., biogas, CH₄, natural gas) and steam to perform the stream reforming. As a result, the integrated reformer 120 generates second output stream 116 including second synthesis gas (e.g., hydrogen-rich synthesis gas). In other words, the integrated reformer 120 converts CO₂, CH₄, and H₂O in the output stream 114 into the second output stream 116 including the second synthesis gas.

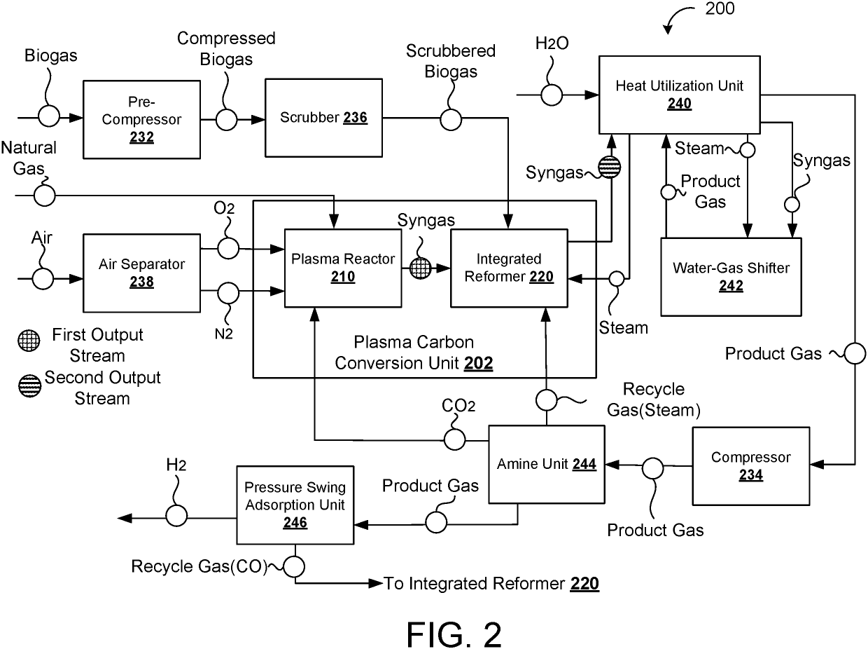

FIG. 2 illustrates an example carbon dioxide (CO₂) reduction and utilization system 200 in accordance with some implementations of this disclosure. The CO₂ reduction and utilization system 200 may include a biogas/natural gas to hydrogen production system.

As shown in FIG. 2, in some implementations, the CO₂ reduction and utilization system 200 includes a PCCU 202 (including a plasma reactor 210 and an integrated reformer 220 in fluid communication with the plasma reactor 210), a pre-compressor 232, a compressor 234, a scrubber 236, an air separator 238, a heat utilization unit 240, a water-gas shift reactor 242, an amine unit 244, and a pressure swing adsorption unit 246.

As shown, in some implementations, an inlet of the pre-compressor 232 is in fluid communication with biogas input source. As a result, the pre-compressor 232 is able to control the pressure of the biogas steam into the system 200 (e.g., to the scrubber 236 as shown in FIG. 2). In some implementations, the pre-compressor 232 increases the pressure of the biogas steam into the system 200. For example, the input biogas may be obtained by the pre-compressor 232 at a pressure of 0.5 atm, 1 atm, 1.5 atm, 2 atm, or some other pressure, and the biogas exiting the pre-compressor 232 (e.g., biogas stream to the scrubber 236) may be at a pressure of 2 atm, 3 atm, 5 atm, 10 atm, 20 atm, 100 atm, or some other pressure.

As shown, in some implementations, an outlet of the pre-compressor 232 is in fluid communication with an inlet of the scrubber 236. As a result, the scrubber 236 receives the biogas (e.g., pressurized biogas) from the pre-compressor 232. In some implementations, the scrubber 236 removes impurities, pollutants, or otherwise harmful components of the biogas received from the pre-compressor 232. For example, the scrubber 236 may include a dry scrubbing process in which harmful substances (e.g., sulfur oxides, particulate matter, acidic gases, etc.) are adsorbed to dry reagents included in the scrubber 236. As another example, the scrubber 236 may include a wet scrubbing process in which the biogas (from the pre-compressor 232) is sprayed with a wet substance (e.g., water) to separate one or more components from the biogas. As shown, an outlet of the scrubber 236 is in fluid communication with the integrated reformer 220. As a result, a stream of the scrubbed biogas (e.g., gas including CH₄ and CO₂) is provided to the integrated reformer 220.

As shown, in some implementations, the air separator 238 obtains an input air stream and separate the input air stream into its constituent components, which may primarily include nitrogen gas (N₂) and oxygen gas (O₂). The air separator 238 may facilitate separation of the components included in the input air stream via fractional distillation, pressure swing adsorption, vacuum pressure swing adsorption, membrane separation, or by any other separation methods. As shown, in some implementations, air separator 238 is in fluid communication with the PCCU 202 (e.g., in fluid communication with the plasma reactor 210 of the PCCU 202). As shown, via the fluid communication, the separated air components may be sent to the plasma reactor 210 of the PCCU 202.

In some implementations, the plasma reactor 210 includes a plasma chamber made of a quartz or ceramic material in which one or more waveguides are configured to facilitate chemical reactions that occur in the plasma chamber. As shown, in some implementations, the plasma reactor 210 is configured to obtain a stream of natural gas (gas including CH₄) from a natural gas input source, the separated air components from the air separator 238, and carbon dioxide from the amine unit 244 as described in further detail below to affect chemical reactions between the inlet streams of gases.

In some implementations, at the plasma reactor 210, the CH₄ from the inlet stream of natural gas, the CO₂ from the amine unit 244 are converted into H₂ and CO (first synthesis gas) using microwave plasma (e.g., exposing the CO₂ and CH₄ with microwave plasma). In some implementations, the plasma reactor 210 instantaneously converts the CO₂ and CH₄ into H₂ and CO without combustion. As a result, the plasma reactor 210 is capable of converting the CO₂ and CH₄ into the first synthesis gas (included in a first output stream) as continuously receiving the CO₂ from the amine unit 244 and CH₄ from the natural gas input source.

In some implementations, at the plasma reactor 210, a mixture of gases including the CO₂, CH₄, and O₂ from the natural gas input source, the amine unit 244, and the air separator 238 is used to generate H₂ and CO using microwave plasma (e.g., exposing the mixture of CO₂, CH₄, and O₂ with microwave plasma). In some implementations, the plasma reactor 210 instantaneously generates H₂ and CO (first synthesis gas) using the mixture of gases including the CO₂, CH₄, and O2 without combustion. As a result, the plasma reactor 210 is capable of generating the first synthesis gas (included in a first output stream) using the mixture of gases including the CO₂, CH₄, and O₂ as continuously receiving the CO₂, CH₄, and O₂.

In some implementations, heat is generated during the synthesis gas conversion process at the plasma reactor 210. The heat (e.g., thermal energy) generated at the plasma reactor 210 increases the temperature of the first output stream as well as the first synthesis gas included in the first output stream. For example, the temperature of first synthesis gas may be between 1500° C. and 2500° C. In some implementations, as discussed above, the integrated reformer 220, which is in fluid communication with the plasma reactor 210, is configured to receive the first output stream including the first synthesis gas from the plasma reactor 210. As a result, at least some of the thermal energy generated at the plasma reactor 210 is transferred to the integrated reformer 220 via the first output stream including the first synthesis gas (e.g., synthesis gas having a temperature greater than 1500° C.).

In some implementations, the integrated reformer 220 includes a discrete reaction unit that is connected to the plasma reactor 210. Additionally or alternatively, the plasma reactor 210 and the integrated reformer 220 may be a single unit such that the formation of the synthesis gas (e.g., second synthesis gas) by the integrated reformer 220 occurs in the plasma-reactor-integrated-reformer combined unit.

As shown, in some implementations, the integrated reformer 220 includes a steam methane reforming reactor or any other reactor vessel that is configured to convert the first synthesis gas (H₂ and CO), CO₂, CH₄, and H₂O from the first output stream of the plasma reactor 210, the scrubbed biogas from the scrubber 236, and steam (e.g., superheated water) from the heat utilization unit 240 into the second synthesis gas (included in a second output stream).

In some implementations, the steam to the integrated reformer 220 is provided by a cooling unit 514/614 as described in further detail below. In some implementations, the cooling unit 514/614 is configured to cool down the first output stream (including the first synthesis gas) from the plasma reactor 210. In some implementations, the cooling unit 514/614 is configured to cool down the first synthesis gas to a range of temperatures (e.g., between 700° C. and 1000° C.) for steam reforming process. In some implementations, the cooling unit 514/614 uses water as coolant to cool down the first output stream (including the first synthesis gas) from the plasma reactor 210. The coolant may include water in any form, including steam. In some implementations, the cooling unit 514/614 is configured to provide the steam which is water heated in the process of cooling the first output stream (including the first synthesis gas) from the plasma reactor 210 to the integrated reformer 220.

As shown, in some implementations, the integrated reformer 220 is configured to obtain a recycle steam from the amine unit 244. In some implementations, the integrated reformer 220 is configured to obtain the steam from the heat utilization unit 240, the steam from the cooling unit 514/614, and/or the stream from the amine unit 244. As a result, additional reactants are provided to facilitate a greater conversion rate of first syngas and biogas into one or more product gases (second synthesis gas in this example).

As shown, the integrated reformer 220 is in fluid communication with the heat utilization unit 240 (e.g., heat exchanger). In some implementations, via the fluid communication, the second output stream (including the second synthesis gas) produced by the integrated reformer 220 is sent to the heat utilization unit 240. In some implementations, the heat utilization unit 240 is configured to cool down the second output stream including the second synthesis gas from the integrated reformer 220 so the second output stream including the second synthesis gas is more suitable for additional processes (e.g., water-gas shift process). In some implementations, the heat utilization unit 240 is configured to cool down the second output stream including the second synthesis gas to a predetermined temperature or a predetermined temperature range (e.g., between 300° C. and 350° C. for water-gas shift process). As shown, in some implementations, water is provided to the heat utilization unit 240 as coolant, process, or makeup water. As the water cools the second output stream including the second synthesis gas down at the heat utilization unit 240, the water absorbs the thermal energy from the second output stream including the second synthesis gas. Accordingly, the state of water changes to gas (e.g., superheated water) which may be provided to the integrated reformer 220 and/or the water-gas shift reactor 242.

As shown, in some implementations, the heat utilization unit 240 includes a power generating unit (e.g., steam turbine). In some implementations, the power generating unit generates power (e.g., electrical power) using the steam generated at the heat utilization unit 240.

As discussed above, the heat utilization unit 240 may include a steam-generating unit that is configured to receive an input stream of water (as coolant, process, or makeup water) and the second output stream including the second synthesis gas generated by the integrated reformer 220. The heat utilization unit 240 may vaporize or heat the input water using the excess heat generated by the plasma reactor 210 that is input to the heat utilization unit 240 by the incoming second output stream (including the second synthesis gas) from the integrated reformer 220, and the generated steam may be sent to the water-gas shift reactor 242. In some implementations, any excess steam from the heat utilization unit 240 is sent to the integrated reformer 220 to facilitate the formation of the second synthesis gas in the integrated reformer 240.

As shown, in some implementations, the heat utilization unit 240 is in fluid communication with the water-gas shift reactor 242. In some implementations, via the fluid communication, the second output stream (including the second synthesis gas), after the cooling down process at the heat utilization unit 240, is sent to the water-gas shift reactor 242. In some implementations, the water-gas shift reactor 242 facilitates formation of H₂ via a water-gas shift reactor 242 in which carbon monoxide and water reversibly react to form CO₂ and H₂. For example, the water-gas shift reactor 242 converts CO and H₂O in the second output stream (including the second synthesis gas) going through the water-gas shift reactor 242 into a third output stream including H₂ and CO₂ (“product gas” in FIG. 2). As shown, in some implementations, after the water-gas shift process at the water-gas shift reactor 242, the product gas is sent back to the heat utilization unit 240 for an additional cooling down process. For example, the heat utilization unit 240 cools the product gas from the water-gas shift reactor 242 down to a predetermined temperature or a predetermined temperature range (e.g., between 40° C. and 50° C.).

As shown, in some implementations, the heat utilization unit 240 is in fluid communication with the compressor 234 configured to receive the product gas (“cool” product gas including H₂, CO₂, and any unreacted or partially reacted materials) from the heat utilization unit 240 and configured to pressurize the product gas. As shown, the compressor 234 is in fluid communication with the amine unit 244. In some implementations, the compressor 234 is operated based on power (e.g., electrical power) generated by the heat utilization unit 240 as discussed above. As a result, the compressor 234 receives the product gas and provides the product gas to the amine unit 244 after the pressurization. For example, the product gas may be obtained by the compressor 234 at a pressure of 0.5 atm, 1 atm, 1.5 atm, 2 atm, or some other pressure, and the product gas exiting the compressor 234 may be at a pressure of 2 atm, 3 atm, 5 atm, 10 atm, 20 atm, 100 atm, or some other pressure.

The amine unit 244 may include various aqueous solutions of amines that react with the product gas exiting the compressor 234 to remove any remaining impurities (e.g., hydrogen sulfide, sulfur oxides, or any other harmful substances). Additionally or alternatively, the amines included in the amine unit 244 may facilitate removal of acidic gases, such as the carbon dioxide. In some implementations, the carbon dioxide removed by the amine unit 244 is recycled and sent back to the plasma reactor 210 to facilitate further syngas reactions (to generate the first synthesis gas). As shown, in some implementations, any partially reacted or unreacted gases in the product gas that entered the amine unit 244 are redirected back to the integrated reformer 220 in a recycle stream to drive the chemical reactions relating to formation of the synthesis gas (second synthesis gas in this example) and/or the hydrogen gas product to a further degree of completion.

As shown, in some implementations, the amine unit 244 is in fluid communication with the pressure swing adsorption unit 246 configured to receive the product gas from the amine unit 244. In some implementations, the product gas including hydrogen gas and any residual gases from the amine unit 234 is sent to a pressure swing adsorption unit 246 to further separate the obtained gases. In some implementations, for example, the pressure swing adsorption unit 246 includes adsorbent materials that separate the hydrogen gas from any other gases that entered the pressure swing adsorption unit 246 by catching compounds passing through the adsorbent materials aside from the hydrogen gas. The gases caught by the adsorbent materials may be desorbed from the adsorbent materials by reducing the pressure in the pressure swing adsorption unit 246, and the desorbed gases (e.g. CO) may be recycled into the PCCU 202 (e.g., to the integrated reformer 220) for further reacting. In other words, the amine unit 244 and the pressure swing adsorption unit 246 remove non-hydrogen gas from the product gas including H₂ and CO₂ from the water-gas shift reactor 242. As a result, the carbon dioxide (CO₂) reduction and utilization system 200 is capable of reducing CO₂ and generating highly purified H₂ (e.g., 99.95% H₂).

Modifications, additions, or omissions may be made to the carbon dioxide reduction and utilization system 200 without departing from the scope of the present disclosure. For example, the designations of different elements in the manner described is meant to help explain concepts described herein and is not limiting. For instance, in some implementations, the pre-compressor 232, scrubber 236, air separator 238, PCCU 202 including the plasma reactor 210 and the integrated reformer 220, heat utilization unit 240, water-gas shift reactor 242, compressor 234, amine unit 244, and pressure swing adsorption unit 246 are delineated in the specific manner described to help with explaining concepts described herein but such delineation is not meant to be limiting. Further, the system of carbon dioxide reduction and utilization 200 may include any number of other elements or may be implemented within other systems or contexts than those described.

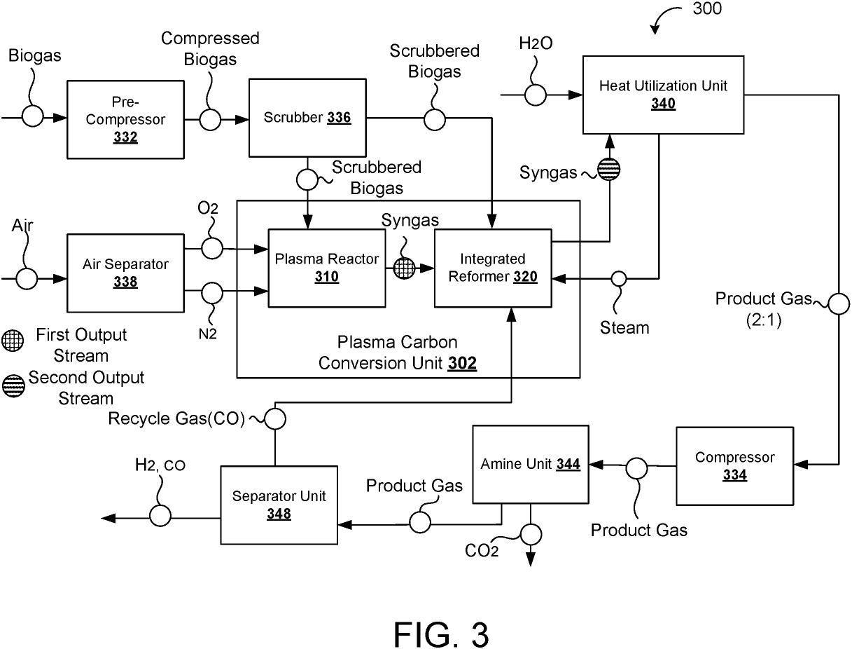

FIG. 3 illustrates an example carbon dioxide (CO₂) reduction and utilization system 300 in accordance with some implementations of this disclosure. The CO₂ reduction and utilization system 300 may include a biogas to synthesis gas production system.

As shown in FIG. 3, in some implementations, the CO₂ reduction and utilization system 300 includes a PCCU 302 (including a plasma reactor 310 and an integrated reformer 320 in fluid communication with the plasma reactor 310), a pre-compressor 332, a compressor 334, a scrubber 336, an air separator 338, a heat utilization unit 340, an amine unit 344, a separator unit 348.

As shown, in some implementations, an inlet of the pre-compressor 332 is in fluid communication with biogas input source. As a result, the pre-compressor 332 is able to control the pressure of the biogas steam into the system 300 (e.g., to the scrubber 336 as shown in FIG. 3). In some implementations, the pre-compressor 332 increases the pressure of the biogas steam into the system 300. For example, the input biogas may be obtained by the pre-compressor 332 at a pressure of 0.5 atm, 1 atm, 1.5 atm, 2 atm, or some other pressure, and the biogas exiting the pre-compressor 332 (e.g., biogas stream to the scrubber 336) may be at a pressure of 2 atm, 3 atm, 5 atm, 10 atm, 20 atm, 100 atm, or some other pressure.

As shown, in some implementations, an outlet of the pre-compressor 332 is in fluid communication with an inlet of the scrubber 336. As a result, the scrubber 336 receives the biogas (e.g., pressurized biogas) from the pre-compressor 332. In some implementations, the scrubber 336 removes impurities, pollutants, or otherwise harmful components of the biogas received from the pre-compressor 332. For example, the scrubber 336 may include a dry scrubbing process in which harmful substances (e.g., sulfur oxides, particulate matter, acidic gases, etc.) are adsorbed to dry reagents included in the scrubber 336. As another example, the scrubber 336 may include a wet scrubbing process in which the biogas (from the pre-compressor 332) is sprayed with a wet substance (e.g., water) to separate one or more components from the biogas. As shown, an outlet of the scrubber 336 is in fluid communication with plasma reactor 310 and the integrated reformer 320. As a result, a stream of the scrubbed biogas (e.g., gas including CH₄ and CO₂) is provided to the plasma reactor 310 and the integrated reformer 320.

As shown, in some implementations, the air separator 338 obtains an input air stream and separates the input air stream into its constituent components, which may primarily include nitrogen gas (N₂) and oxygen gas (O₂). The air separator 338 may facilitate separation of the components included in the input air stream via fractional distillation, pressure swing adsorption, vacuum pressure swing adsorption, membrane separation, or by any other separation methods. As shown, in some implementations, air separator 338 is in fluid communication with the PCCU 302 (e.g., in fluid communication with the plasma reactor 310 of the PCCU 302). As shown, via the fluid communication, the separated air components may be sent to the plasma reactor 310 of the PCCU 302.

In some implementations, the plasma reactor 310 includes a plasma chamber made of a quartz or ceramic material in which one or more waveguides are configured to facilitate chemical reactions that occur in the plasma chamber. As shown, in some implementations, the plasma reactor 310 is configured to obtain a stream of biogas from the scrubber 336, the separated air components from the air separator 338 to affect chemical reactions between the inlet streams of gases.

In some implementations, at the plasma reactor 310, the CO₂ and CH₄ in the scrubbed biogas stream from the scrubber 336 are converted into H₂ and CO (first synthesis gas) using microwave plasma (e.g., exposing the CO₂ and CH₄ with microwave plasma). In some implementations, the plasma reactor 310 instantaneously converts the CO₂ and CH₄ into H₂ and CO without combustion. As a result, the plasma reactor 310 is capable of converting the CO₂ and CH₄ into the first synthesis gas (included in a first output stream) as continuously receiving the scrubbed biogas.

In some implementations, at the plasma reactor 310, a mixture of gases including the CO₂, CH₄, and O₂ from the scrubber 336 and the air separator 338 is used to generate H₂ and CO using microwave plasma (e.g., exposing the mixture of CO₂, CH₄, and O₂ with microwave plasma). In some implementations, the plasma reactor 310 instantaneously generates H₂ and CO (first synthesis gas) using the mixture of gases including the CO₂, CH₄, and O₂ without combustion. As a result, the plasma reactor 310 is capable of generating the first synthesis gas (included in a first output stream) using the mixture of gases including the CO₂, CH₄, and O₂ as continuously receiving the CO₂, CH₄, and O₂.

In some implementations, heat is generated during the synthesis gas conversion process at the plasma reactor 310. The heat (e.g., thermal energy) generated at the plasma reactor 310 increases the temperature of the first output stream as well as the first synthesis gas included in the first output stream. For example, the temperature of first synthesis gas may be between 1500° C. and 2500° C. In some implementations, as discussed above, the integrated reformer 320, which is in fluid communication with the plasma reactor 310, is configured to receive the first output stream including the first synthesis gas from the plasma reactor 310. As a result, at least some of the thermal energy generated at the plasma reactor 310 is transferred to the integrated reformer 320 via the first output stream including the first synthesis gas (e.g., synthesis gas having a temperature greater than 1500° C.).

In some implementations, the integrated reformer 320 includes a discrete reaction unit that is connected to the plasma reactor 310. Additionally or alternatively, the plasma reactor 310 and the integrated reformer 320 may be a single unit such that the formation of the synthesis gas (e.g., second synthesis gas) by the integrated reformer 320 occurs in the plasma-reactor-integrated-reformer combined unit.

In some implementations, the integrated reformer 320 includes a steam methane reforming reactor or any other reactor vessel that is configured to convert the first synthesis gas (H₂ and CO), CO₂, CH₄, and H₂O from the first output stream of the plasma reactor, the scrubbed biogas from the scrubber 336, and steam (e.g., superheated water) from the heat utilization unit 340 into the second synthesis gas (included in a second output stream).

In some implementations, the separator unit 348 (as described in further detail below) provides additional CO to the integrated reformer 320. Accordingly, as shown, in some implementations, the integrated reformer 320 includes a steam methane reforming reactor or any other reactor vessel that is configured to convert the first synthesis gas (H₂ and CO), CO₂, CH₄, H₂O, CO from the first output stream of the plasma reactor 310, the scrubbed biogas from the scrubber 336, steam (e.g., superheated water) from the heat utilization unit 340, and the recycle gas from the separator unit 348 into the second synthesis gas (included in the second output stream). As a result, additional reactants are provided to facilitate a greater conversion rate of first syngas and biogas into one or more product gases (second synthesis gas in this example).

In some implementations, the synthesis gas (second synthesis gas in this example) yielded by chemical reactions occurring in the PCCU 302 may be generated more efficiently than synthesis gas yielded by other existing chemical processes. Additionally or alternatively, additional heat may not be needed to facilitate the synthesis gas reactions occurring in the integrated reformer 320 because the heat generated by the reactions occurring in the plasma reactor 310 may be input into the integrated reformer 320.

In some implementations, the steam to the integrated reformer 320 is provided by a cooling unit 514/614 as described in further detail below. In some implementations, the cooling unit 514/614 is configured to cool down the first output stream (including the first synthesis gas) from the plasma reactor 310. In some implementations, the cooling unit 514/614 is configured to cool down the first synthesis gas to a range of temperatures (e.g., between 700° C. and 1000° C.) for steam reforming process. In some implementations, the cooling unit 514/614 uses water as coolant to cool down the first output stream (including the first synthesis gas) from the plasma reactor 310. In some implementations, the cooling unit 514/614 is configured to provide the steam which is water heated in the process of cooling the first output stream (including the first synthesis gas) from the plasma reactor 310 to the integrated reformer 320.

As shown, the integrated reformer 320 is in fluid communication with the heat utilization unit 340 (e.g., heat exchanger). In some implementations, via the fluid communication, the second output stream (including the second synthesis gas) produced by the integrated reformer 320 is sent to the heat utilization unit 340. In some implementations, the heat utilization unit 340 is configured to cool down the second output stream including the second synthesis gas from the integrated reformer 320 so the second output stream including the second synthesis gas is more suitable for additional processes (e.g., CO₂ removal process at the amine unit 344). In some implementations, the heat utilization unit 340 is configured to cool down the second output stream including the second synthesis gas to a predetermined temperature or a predetermined temperature range (e.g., between 40° C. and 50° C.). As shown, in some implementations, water is provided to the heat utilization unit 340 as coolant, process, or makeup water. As the water cools the second output stream including the second synthesis gas down at the heat utilization unit 340, the water absorbs the thermal energy from the second output stream including the second synthesis gas. Accordingly, the state of water changes to gas (e.g., superheated water) which may be provided to the integrated reformer 320.

As shown, in some implementations, the heat utilization unit 340 includes a power generating unit (e.g., steam turbine). In some implementations, the power generating unit generates power (e.g., electrical power) using the steam generated at the heat utilization unit 340.

As discussed above, the heat utilization unit 340 may include a steam-generating unit that is configured to receive an input stream of water (as coolant, process, or makeup water) and the second output stream including the second synthesis gas generated by the integrated reformer 320. The heat utilization unit 340 may vaporize or heat the input water using the excess heat generated by the plasma reactor 310 that is input to the heat utilization unit 340 by the incoming second output stream (including the second synthesis gas) from the integrated reformer 320, and the generated steam may be sent to the integrated reformer 320 to facilitate the formation of the second synthesis gas in the integrated reformer 340.

In some implements, the second synthesis gas, included in the second output stream, includes hydrogen gas and carbon monoxide in a ratio ranging from 0.5:1 to 2.9:1 (e.g., at a ratio of 2:1 as shown in FIG. 3). The ratio of the second synthesis gas formed may be dependent on a volume of biogas input into the pre-compressor 332, a volume of air input into the air separator 338, an amount of energy supplied to the plasma reactor 310 or the integrated reformer 320 of the PCCU 302, an amount of steam sent to the integrated reformer 320 from the heat utilization unit 340, or some combination thereof. For example, a ratio of hydrogen gas to carbon monoxide may range from approximately 0.5:1 to approximately 1.5:1 if there is no recycle stream of steam from the heat utilization unit 340 to the integrated reformer 320, while the ratio of hydrogen gas to carbon monoxide may increase to approximately 1.3:1 to approximately 2.9:1 depending on the amount of steam recycled (or provided) to the integrated reformer 320.

As shown, in some implementations, the heat utilization unit 340 is in fluid communication with the compressor 334 configured to receive the second output stream that is cooled by the heat utilization unit 340 (including the second synthesis gas) from the heat utilization unit 340 and configured to pressurize the second output stream. As shown, the compressor 334 is in fluid communication with the amine unit 344. In some implementations, the compressor 334 is operated based on power (e.g., electrical power) generated by the heat utilization unit 340 as discussed above. As a result, the compressor 334 receives the second output stream that is cooled by the heat utilization unit 340 and provides the “cooled” second output stream to the amine unit 344 after the pressurization. For example, the second output stream may be obtained by the compressor 334 at a pressure of 0.5 atm, 1 atm, 1.5 atm, 2 atm, or some other pressure, and the “cooled” second output stream exiting the compressor 334 may be at a pressure of 2 atm, 3 atm, 5 atm, 10 atm, 20 atm, 100 atm, or some other pressure.

The amine unit 344 may include various aqueous solutions of amines that react with the “cool” second output stream exiting the compressor 334 to remove any remaining impurities (e.g., hydrogen sulfide, sulfur oxides, or any other harmful substances). Additionally or alternatively, the amines included in the amine unit 344 may facilitate removal of acidic gases, such as the carbon dioxide.

As shown, in some implementations, the amine unit 344 is in fluid communication with the separator unit 348 configured to receive the “cooled” second output stream (processed or treated by the amine unit 344) from the amine unit 344.

As a result, the “cooled” second output stream (processed by the amine unit 344) is sent to the separator unit 348 that splits the various components of the second output stream. For example, the separator unit 348 may include a pressure swing adsorption unit to separate the components included in the “cooled” second output stream (processed by the amine unit 344) in which the pressure swing adsorption unit includes adsorbent materials that separate gas components that entered the pressure swing adsorption unit by filtering compounds passing through the adsorbent materials. The gases caught by the adsorbent materials may be desorbed from the adsorbent materials by reducing the pressure in the pressure swing adsorption unit, and the desorbed gases (e.g., CO) may be recycled into the PCCU 302 (e.g., to the integrated reformer 302) for further reaction. In some implementations, a first portion of the “cooled” second output stream (processed by the amine unit 344) is processed by the pressure swing adsorption unit, and a second portion of the “cooled” second output stream (processed by the amine unit 344) bypasses the pressure swing adsorption unit. In some implementations, by varying the amount of first portion of the “cooled” second output stream (processed by the amine unit 344) processed by the pressure swing adsorption unit, the separator unit 348, configured to output the sum of the first and second portions, is able to produce the synthesis gas with various H₂: CO ratios. As a result, the carbon dioxide (CO₂) reduction and utilization system 300 is capable of reducing CO₂ and generating synthesis gas with various H₂: CO ratios.

Modifications, additions, or omissions may be made to the carbon dioxide reduction and utilization system 300 without departing from the scope of the present disclosure. For example, the designations of different elements in the manner described is meant to help explain concepts described herein and is not limiting. For instance, in some implementations, the pre-compressor 332, scrubber 336, air separator 338, PCCU 302 including the plasma reactor 310 and the integrated reformer 320, heat utilization unit 340, compressor 334, amine unit 344, and separator unit 348 are delineated in the specific manner described to help with explaining concepts described herein but such delineation is not meant to be limiting. Further, the carbon dioxide reduction and utilization system 300 may include any number of other elements or may be implemented within other systems or contexts than those described.

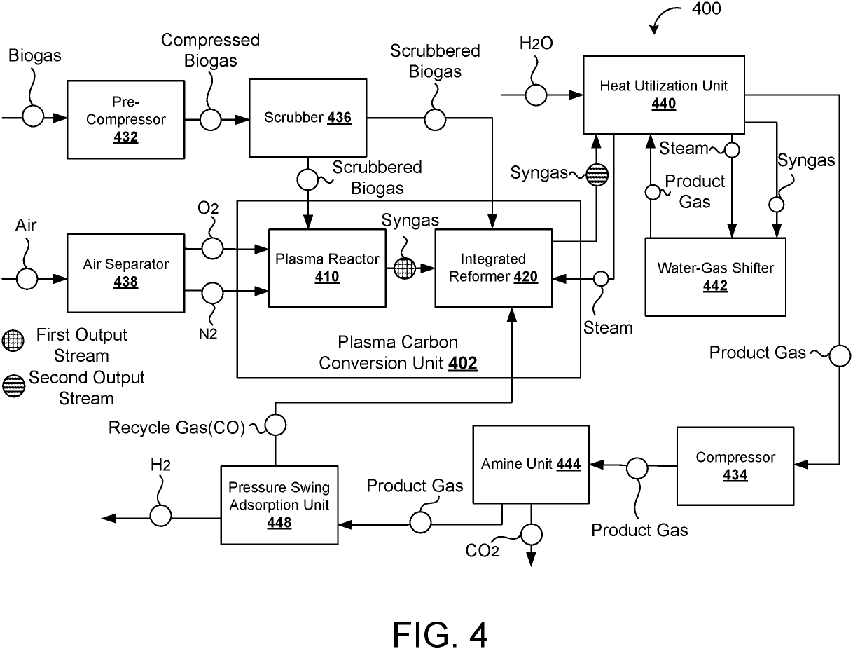

FIG. 4 illustrates an example carbon dioxide (CO₂) reduction and utilization system 400 in accordance with some implementations of this disclosure. The CO₂ reduction and utilization system 400 may include a biogas to hydrogen production system.

As shown in FIG. 4, in some implementations, the CO₂ reduction and utilization system 400 includes a PCCU 402 (including a plasma reactor 410 and an integrated reformer 420 in fluid communication with the plasma reactor 410), a pre-compressor 432, a compressor 434, a scrubber 436, an air separator 438, a heat utilization unit 440, a water-gas shift reactor 442, an amine unit 444, and a pressure swing adsorption unit 446.

As shown, in some implementations, an inlet of the pre-compressor 432 is in fluid communication with biogas input source. As a result, the pre-compressor 432 is able to control the pressure of the biogas steam into the system 400 (e.g., to the scrubber 436 as shown in FIG. 4). In some implementations, the pre-compressor 432 increases the pressure of the biogas steam into the system 400. For example, the input biogas may be obtained by the pre-compressor 432 at a pressure of 0.5 atm, 1 atm, 1.5 atm, 2 atm, or some other pressure, and the biogas exiting the pre-compressor 432 (e.g., biogas stream to the scrubber 436) may be at a pressure of 2 atm, 3 atm, 5 atm, 10 atm, 20 atm, 100 atm, or some other pressure.

As shown, in some implementations, an outlet of the pre-compressor 432 is in fluid communication with an inlet of the scrubber 436. As a result, the scrubber 436 receives the biogas (e.g., pressurized biogas) from the pre-compressor 432. In some implementations, the scrubber 436 removes impurities, pollutants, or otherwise harmful components of the biogas received from the pre-compressor 432. For example, the scrubber 436 may include a dry scrubbing process in which harmful substances (e.g., sulfur oxides, particulate matter, acidic gases, etc.) are adsorbed to dry reagents included in the scrubber 436. As another example, the scrubber 436 may include a wet scrubbing process in which the biogas (from the pre-compressor 432) is sprayed with a wet substance (e.g., water) to separate one or more components from the biogas. As shown, an outlet of the scrubber 436 is in fluid communication with the plasma reactor 410 and the integrated reformer 420. As a result, a stream of the scrubbed biogas (e.g., gas including CH₄ and CO₂) is provided to the plasma reactor 410 and the integrated reformer 420.

As shown, in some implementations, the air separator 438 obtains an input air stream and separate the input air stream into its constituent components, which may primarily include nitrogen gas (N₂) and oxygen gas (O₂). The air separator 438 may facilitate separation of the components included in the input air stream via fractional distillation, pressure swing adsorption, vacuum pressure swing adsorption, membrane separation, or by any other separation methods. As shown, in some implementations, air separator 438 is in fluid communication with the PCCU 402 (e.g., in fluid communication with the plasma reactor 410 of the PCCU 402). As shown, via the fluid communication, the separated air components may be sent to the plasma reactor 410 of the PCCU 402.

In some implementations, the plasma reactor 410 includes a plasma chamber made of a quartz or ceramic material in which one or more waveguides are configured to facilitate chemical reactions that occur in the plasma chamber. As shown, in some implementations, the plasma reactor 410 is configured to obtain a stream of biogas (e.g., scrubbed biogas) from the scrubber 436, the separated air components from the air separator 438 to affect chemical reactions between the inlet streams of gases.

In some implementations, at the plasma reactor 410, the CO₂ and CH₄ in the scrubbed biogas stream from the scrubber 436 are converted into H₂ and CO (first synthesis gas) using microwave plasma (e.g., exposing the CO₂ and CH₄ with microwave plasma). In some implementations, the plasma reactor 410 instantaneously converts the CO₂ and CH₄ into H₂ and CO without combustion. As a result, the plasma reactor 410 is capable of converting the CO₂ and CH₄ into the first synthesis gas (included in a first output stream) as continuously receiving the CO₂ and CH₄ from the scrubber 436.

In some implementations, at the plasma reactor 410, a mixture of gases including the CO₂, CH₄, and O₂ from the scrubber 436 and the air separator 438 is used to generate H₂ and CO using microwave plasma (e.g., exposing the mixture of CO₂, CH₄, and O₂ with microwave plasma). In some implementations, the plasma reactor 410 instantaneously generates H₂ and CO (first synthesis gas) using the mixture of gases including the CO₂, CH₄, and O₂without combustion. As a result, the plasma reactor 410 is capable of generating the first synthesis gas (included in a first output stream) using the mixture of gases including the CO₂, CH₄, and O₂ as continuously receiving the CO₂, CH₄, and O₂.

In some implementations, heat is generated during the synthesis gas conversion process at the plasma reactor 410. The heat (e.g., thermal energy) generated at the plasma reactor 410 increases the temperature of the first output stream as well as the first synthesis gas included in the first output stream. For example, the temperature of first synthesis gas may be between 1500° C. and 2500° C. In some implementations, as discussed above, the integrated reformer 420, which is in fluid communication with the plasma reactor 410, is configured to receive the first output stream including the first synthesis gas from the plasma reactor 410. As a result, at least some of the thermal energy generated at the plasma reactor 410 is transferred to the integrated reformer 420 via the first output stream including the first synthesis gas (e.g., synthesis gas having a temperature greater than 1500° C.).

In some implementations, the integrated reformer 420 includes a discrete reaction unit that is connected to the plasma reactor 410. Additionally or alternatively, the plasma reactor 410 and the integrated reformer 420 may be a single unit such that the formation of the synthesis gas (e.g., second synthesis gas) by the integrated reformer 420 occurs in the plasma-reactor-integrated-reformer combined unit.

In some implementations, the pressure awing adsorption unit 448 (as described in further detail below) provides additional CO to the integrated reformer 420. Accordingly, as shown, in some implementations, the integrated reformer 420 includes a steam methane reforming reactor or any other reactor vessel that is configured to convert the first synthesis gas (H₂ and CO), CO₂, CH₄, CO, and H₂O from the first output stream of the plasma reactor 410, the scrubbed biogas from the scrubber 436, the recycled gas from the pressure swing adsorption unit 448, and steam (e.g., superheated water) from the heat utilization unit 440 into the second synthesis gas (included in a second output stream).

In some implementations, the steam to the integrated reformer 420 is provided by a cooling unit 514/614 as described in further detail below. In some implementations, the cooling unit 514/614 is configured to cool down the first output stream (including the first synthesis gas) from the plasma reactor 410. In some implementations, the cooling unit 514/614 is configured to cool down the first synthesis gas to a range of temperatures (e.g., between 700° C. and 1000° C.) for steam reforming process. In some implementations, the cooling unit 514/614 uses water as coolant to cool down the first output stream (including the first synthesis gas) from the plasma reactor 410. In some implementations, the cooling unit 514/614 is configured to provide the steam which is water heated in the process of cooling the first output stream (including the first synthesis gas) from the plasma reactor 410 to the integrated reformer 420.

In some implementations, the integrated reformer 420 is configured to obtain the steam from the heat utilization unit 440 and the steam from the cooling unit 514/614. As a result, additional reactants are provided to facilitate a greater conversion rate of first syngas and biogas into one or more product gases (second synthesis gas in this example).

As shown, the integrated reformer 420 is in fluid communication with the heat utilization unit 440 (e.g., heat exchanger). In some implementations, via the fluid communication, the second output stream (including the second synthesis gas) produced by the integrated reformer 420 is sent to the heat utilization unit 440. In some implementations, the heat utilization unit 440 is configured to cool down the second output stream including the second synthesis gas from the integrated reformer 420 so the second output stream including the second synthesis gas is more suitable for additional processes (e.g., water-gas shift process). In some implementations, the heat utilization unit 440 is configured to cool down the second output stream including the second synthesis gas to a predetermined temperature or a predetermined temperature range (e.g., between 300° C. and 350° C.). As shown, in some implementations, water is provided to the heat utilization unit 440 as coolant, process, or makeup water. As the water cools the second output stream including the second synthesis gas down at the heat utilization unit 440, the water absorbs the thermal energy from the second output stream including the second synthesis gas. Accordingly, the state of water changes to gas (e.g., superheated water) which may be provided to the integrated reformer 420 and/or the water-gas shift reactor 442.

As shown, in some implementations, the heat utilization unit 440 includes a power generating unit (e.g., steam turbine). In some implementations, the power generating unit generates power (e.g., electrical power) using the steam generated at the heat utilization unit 440.

As discussed above, the heat utilization unit 440 may include a steam-generating unit that is configured to receive an input stream of water (as coolant, process, or makeup water) and the second output stream including the second synthesis gas generated by the integrated reformer 420. The heat utilization unit 440 may vaporize or heat the input water using the excess heat generated by the plasma reactor 410 that is input to the heat utilization unit 440 by the incoming second output stream (including the second synthesis gas) from the integrated reformer 420, and the generated steam may be sent to the water-gas shift reactor 442. In some implementations, any excess steam from the heat utilization unit 440 is sent to the integrated reformer 420 to facilitate the formation of the second synthesis gas in the integrated reformer 440.

As shown, in some implementations, the heat utilization unit 440 is in fluid communication with the water-gas shift reactor 442. In some implementations, via the fluid communication, the second output stream (including the second synthesis gas), after the cooling down process at the heat utilization unit 240, is sent to the water-gas shift reactor 442. In some implementations, the water-gas shifter reactor 442 facilitates formation of H₂ via a water-gas shift reactor 442 in which carbon monoxide and water reversibly react to form CO₂ and H₂. For example, the water-gas shift reactor 442 converts CO and H₂O in the second output stream (including the second synthesis gas) going through the water-gas shift reactor 442 into a third output stream including H₂ and CO₂ (“product gas” in FIG. 4). As shown, in some implementations, after the water-gas shift process at the water-gas shift reactor 442, the product gas is sent back to the heat utilization unit 440 for an additional cooling down process. For example, the heat utilization unit 440 cools the product gas from the water-gas shift reactor 442 down to a predetermined temperature or a predetermined temperature range (e.g., between 40° C. and 50° C.).

As shown, in some implementations, the heat utilization unit 440 is in fluid communication with the compressor 434 configured to receive the product gas (“cool” product gas including H₂, CO₂, and any unreacted or partially reacted materials) from the heat utilization unit 440 and configured to pressurize the product gas. As shown, the compressor 434 is in fluid communication with the amine unit 444. In some implementations, the compressor 434 is operated based on power (e.g., electrical power) generated by the heat utilization unit 440 as discussed above. As a result, the compressor 434 receives the product gas and provides the product gas to the amine unit 444 after the pressurization. For example, the product gas may be obtained by the compressor 434 at a pressure of 0.5 atm, 1 atm, 1.5 atm, 2 atm, or some other pressure, and the product gas exiting the compressor 434 may be at a pressure of 2 atm, 3 atm, 5 atm, 10 atm, 20 atm, 100 atm, or some other pressure.

The amine unit 444 may include various aqueous solutions of amines that react with the product gas exiting the compressor 434 to remove any remaining impurities (e.g., hydrogen sulfide, sulfur oxides, or any other harmful substances). Additionally or alternatively, the amines included in the amine unit 444 may facilitate removal of acidic gases, such as the carbon dioxide.

As shown, in some implementations, the amine unit 444 is in fluid communication with the pressure swing adsorption unit 446 configured to receive the product gas from the amine unit 444. In some implementations, the product gas including hydrogen gas and any residual gases from the amine unit 434 is sent to a pressure swing adsorption unit 446 to further separate the obtained gases. In some implementations, for example, the pressure swing adsorption unit 446 includes adsorbent materials that separate the hydrogen gas from any other gases that entered the pressure swing adsorption unit 446 by catching compounds passing through the adsorbent materials aside from the hydrogen gas. The gases caught by the adsorbent materials may be desorbed from the adsorbent materials by reducing the pressure in the pressure swing adsorption unit 446, and the desorbed gases (e.g. CO) may be recycled into the PCCU 402 (e.g., to the integrated reformer 420) for further reaction. In other words, the amine unit 444 and the pressure swing adsorption unit 446 remove non-hydrogen gas from the product gas including H₂ and CO₂ from the water-gas shift reactor 442. As a result, the carbon dioxide (CO₂) reduction and utilization system 400 is capable of removing CO₂ and generating highly purified H₂ (e.g., 99.95% H₂).

Modifications, additions, or omissions may be made to the carbon dioxide reduction and utilization system 400 without departing from the scope of the present disclosure. For example, the designations of different elements in the manner described is meant to help explain concepts described herein and is not limiting. For instance, in some implementations, the pre-compressor 432, scrubber 436, air separator 438, PCCU 402 including the plasma reactor 410 and the integrated reformer 420, heat utilization unit 440, water-gas shift reactor 442, compressor 434, amine unit 444, and pressure swing adsorption unit 446 are delineated in the specific manner described to help with explaining concepts described herein but such delineation is not meant to be limiting. Further, the system of carbon dioxide reduction and utilization 400 may include any number of other elements or may be implemented within other systems or contexts than those described.

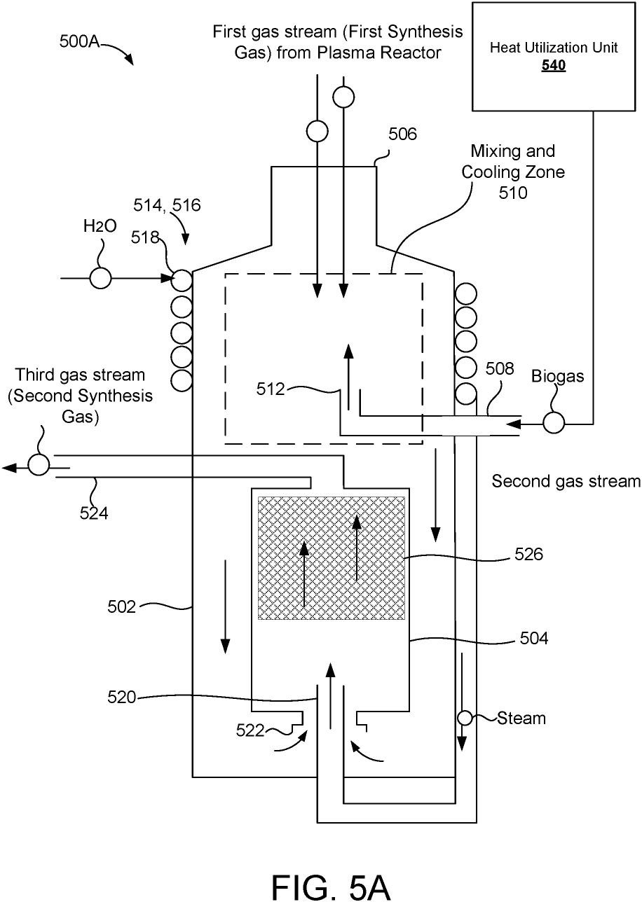

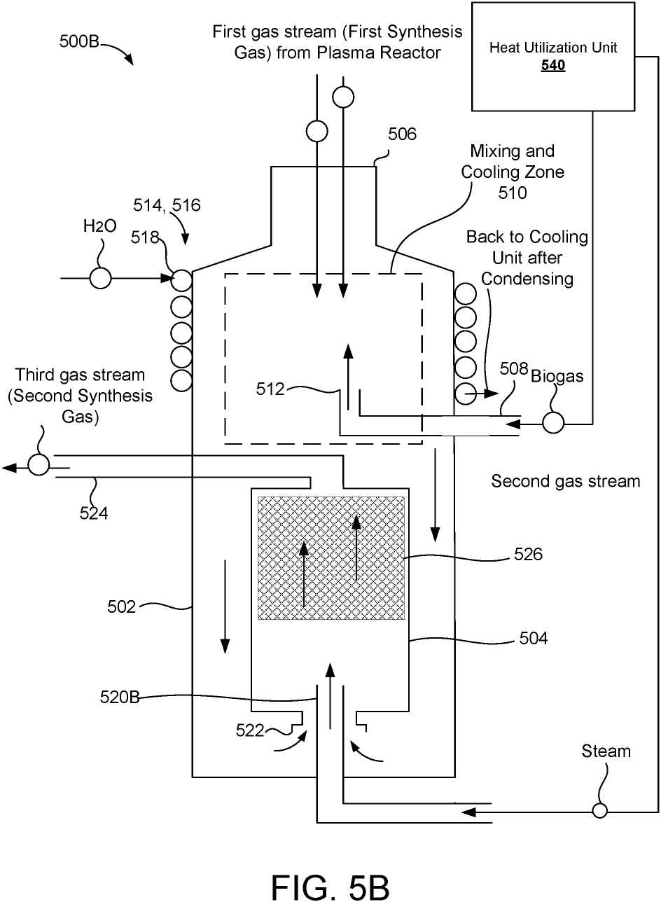

FIG. 5A illustrates a cross-sectional view of an example integrated reformer 500A in accordance with some implementations of this disclosure.

As shown, in some implementations, the integrated reformer 500A includes an outer chamber 502 and the reaction chamber 504.

As shown, in some implementations, the outer chamber 502 includes a first inlet 506 configured to obtain a first gas stream (e.g., gas stream including a first synthesis gas from a plasma reactor) and a second inlet 508 configured to obtain a second gas stream (e.g., gas stream including hydrocarbon fuel such as biogas, CH₄, natural gas, or any combinations thereof).

As shown, in some implementations, the second gas stream is from a heat utilization 540 (e.g., heat utilization unit similar to the heat utilization unit 240/340/440 in FIGS. 2/3/4). In some implementations, the second gas stream is heated or cooled by the heat utilization unit 540 to a pre-determined temperature before introducing to the chamber 502.

In some implementations, the integrated reformer 500A provides a mixing and cooling zone 510 in the outer chamber 502 where the first gas stream and the second gas stream are being mixed and cooled. As shown, in some implementations, to mix the first gas stream and the second gas stream together in the mixing and the cooling zone 510, a first end 512 of the second inlet 508 is extended into the mixing and cooling zone 510 via a wall of the outer chamber 502. As shown, in some implementations, the first end 512 of the second inlet 508 in the outer chamber 502 is bent so that the first end 512 of the second inlet 508 is directed to the first inlet 506. Accordingly, the first gas stream and the second gas stream are collided directly at the mixing and the cooling zone 510 for better mixing.

In some implementations, the first gas stream is from a plasma reactor such as the first output stream (including the first synthesis gas) from the plasma reactor described in relation to FIGS. 2, 3, and 4. As discussed, the first output stream (first gas stream in FIG. 5) from the plasma reactor has a high temperature (e.g., temperature range between 1500° C. and 2500° C.) due to operations of the plasma reactor.

By mixing the first gas stream (with the high temperature) with the second gas stream (biogas in this example) with a temperature relatively lower than the first gas stream, the temperature of the mixture of the first gas stream and the second gas stream is lower than the temperature of the first gas stream. In some implementations, to efficiently cool down the mixture of the first gas stream and the second gas stream to a predetermined temperature or a predetermined temperature range so that the temperature of the mixture of the first gas stream and the second gas stream is within a range (e.g., between 700° C. and 1000° C.) suitable for steam reforming (in the reaction chamber 504 along with steam), a cooling unit 514 is coupled to the outer chamber 502.

As shown, in some implementations, the integrated reformer 500A includes the cooling unit 514 disposed adjacent to mixing and cooling zone 510. As shown, in some implementations, the cooling unit 514 surrounds the mixing and cooling zone 510. As shown, in some implementations, the cooling unit 514 includes a tube 516 (or a pipe) disposed or wrapped around the outer chamber 502 adjacent to the mixing and cooling zone 510. As shown, in some implementations, the mixing and cooling zone 510 is provided between the first inlet 506 and the reaction chamber 504.

In some implementations, the cooling unit 514 uses water as coolant to cool down the mixture of the first gas stream and/or the second gas stream. For example, water is supplied to a first end 518 of the tube 516 disposed around the outer chamber 502. As the water flows within the tube 516, the water absorbs the thermal energy (heat) from the mixture of the first gas stream and/or the second gas stream, and becomes steam (e.g., water in gas state).

As shown, in some implementations, the cooling unit 514 is configured to provide the steam to the reaction chamber 504. As shown, a second end 520 of the tube 516 is disposed in the reaction chamber 504 adjacent to a mixture gas inlet 522 of the reaction chamber 504. As shown, in some implementations, the second end 520 of the tube 516 is connected to (or in fluid communication with) the reaction chamber 504 via the mixture gas inlet 522 of the reaction chamber 504.

As shown, in some implementations, the second end 520 of the tube 516 is directed to a side opposite to the side of the mixture gas inlet 522. As shown, the mixture of the first gas stream and the second gas stream is provided to the reaction chamber 504 via the mixture gas inlet 522. As a result, the mixture of the first gas stream and the second gas stream is mixed with the steam in the reaction chamber 504. As a result, the reaction chamber 504 generates a third gas stream (including second synthesis gas) based on the first gas stream, the second gas streams, and the steam using the steam reforming. As shown, the reaction chamber 504 includes an outlet 524 to output the third gas stream (including the second synthesis gas) generated by the integrated reformer 500A. As shown, in some implementations, the reaction chamber 504 includes a catalyst 526 to promote more reactions for synthesis gas production (e.g., catalytic process). In some implementations, the catalyst includes a porous material or structure (e.g., mesh, plurality of tubes or pipes, membrane). As shown, the catalyst 526 is disposed between the outlet 524 and the mixture gas inlet 522 so the mixtures of the first gas stream, the second gas steam, and the steam from the cooling unit 514 can efficiently pass through the catalyst 526 for catalytic process.

Modifications, additions, or omissions may be made to the integrated reformer 500A without departing from the scope of the present disclosure. For example, the coolant in the cooling unit 514 is only used for cooling the mixture of the first gas stream and/or the second gas stream and steam from the heat utilization unit (as discussed above) is used for the steam reforming process. In this case, the coolant, after cooling the mixture of the first gas stream and/or the second stream, may be re-used by the cooling unit 514 after condensing.

FIG. 5B illustrates a cross-sectional view of an example integrated reformer 500B in accordance with some implementations of this disclosure.

As shown, the integrated reformer 500B is substantially similar to the integrated reformer 500A in FIG. 5A. Therefore duplicated detail description is not repeated here.

As shown, in some implementations, a steam inlet 520B of the reaction chamber 504 is in fluid communication with a heat utilization unit 540. In some implementation, in addition to the coolant from the cooling device 514, steam from the heat utilization unit is provided to the reaction chamber 504 to generate the third gas stream. In some implementation, in alternative to the coolant from the cooling device 514, the steam from the heat utilization unit is provided to the reaction chamber 504 to generate the third gas stream.

In some implementations, the coolant in the cooling unit 514 is only used for cooling the mixture of the first gas stream and/or the second gas stream and steam from the heat utilization unit 540 is used for the steam reforming process. In this case, the coolant, after cooling the mixture of the first gas stream and/or the second stream, may be re-used by the cooling unit 514 after condensing/cooling.

In some implementations, the coolant includes water. In some implementations, the coolant includes CO₂. In some implementations, the coolant includes CH₄. In some implementations, the coolant includes oil. In some implementations, the coolant includes a material that is suitable to cool down the first gas stream (e.g., temperature above 1500° C.).

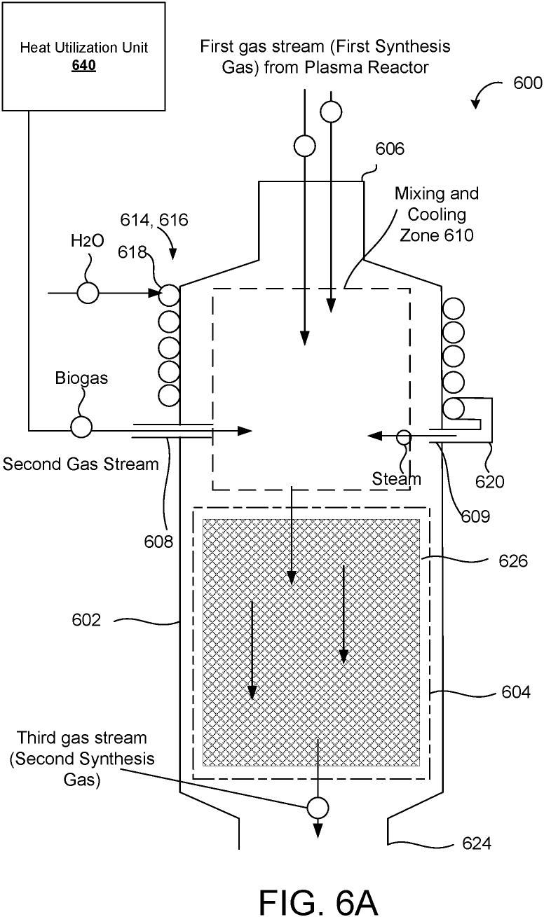

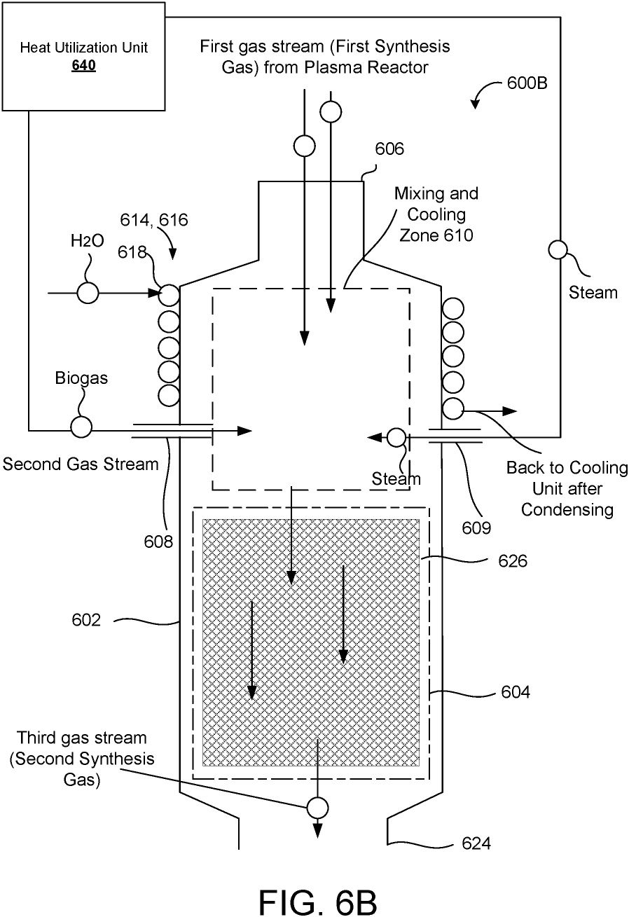

FIG. 6A illustrates a cross-sectional an example integrated reformer 600A in accordance with some implementations of this disclosure.

As shown, in some implementations, the integrated reformer 600A includes a chamber 602 (as referred to as outer chamber).

As shown, in some implementations, the chamber 602 includes a first inlet 606 configured to obtain a first gas stream (e.g., gas stream including a first synthesis gas), a second inlet 608 configured to obtain a second gas stream (e.g., gas stream including hydrocarbon fuel such as biogas, CH₄, natural gas, or any combinations thereof), and a third inlet 609 to obtain steam.

As shown, in some implementations, the second gas stream is from a heat utilization 640 (e.g., heat utilization unit similar to the heat utilization unit 240/340/440 in FIGS. 2/3/4). In some implementations, the second gas stream is heated or cooled by the heat utilization unit 640 to a pre-determined temperature before introducing to the chamber 602.

In some implementations, the chamber 602 provides a mixing and cooling zone 610 in the chamber 602 where the first gas stream, the second gas stream, and the steam are being mixed and cooled.

In some implementations, the first gas stream is from a plasma reactor such as the first output stream (including the first synthesis gas) from a plasma reactor described in relation to FIGS. 2, 3, and 4. As discussed, the first output stream (first gas stream in FIG. 6) from the plasma reactor has a high temperature (e.g., temperature range between 1500° C. and 2500° C.) due to operations of the plasma reactor.

By mixing the first gas stream (with the high temperature) with the second gas stream (biogas in this example) with a temperature relatively lower than the first gas stream and the steam with a temperature relatively lower than the first gas stream, the temperature of the mixture of the first gas stream, the second gas stream and the steam is lower than the temperature of the first gas stream. In some implementations, to efficiently cool down the mixture of the first gas stream, the second gas stream, and the steam to a predetermined temperature or a predetermined temperature range (e.g., between 700° C. and 1000° C.) suitable for steam reforming, a cooling unit 614 is coupled to the chamber 602.

As shown, in some implementations, the integrated reformer 600A includes the cooling unit 614 disposed adjacent to mixing and cooling zone 610. As shown, in some implementations, the cooling unit 614 includes a tube 616 (or a pipe) disposed around the outer chamber 602 adjacent to the mixing and cooling zone 610. As shown, in some implementations, the mixing and cooling zone 610 is between the first inlet 606 and a reaction zone 604. As shown, in some implementations, when a catalyst 626 is included in the integrated reformer 600A, the mixing and cooling zone 610 is between the first inlet 606 and the catalyst 626 disposed in the chamber 602. As shown, in some implementations, the mixing and cooling zone 610 is between the second inlet 608 and the third inlet 609.

In some implementations, the cooling unit 614 uses water as coolant to cool down the mixture of the first gas stream. For example, water is supplied to a first end 618 of the tube 616 disposed around the chamber 602. As the water flows within the tube 616, the water absorbs the thermal energy (heat) from the first gas stream and becomes steam.

As shown, in some implementations, the cooling unit 614 is configured to provide the steam to the chamber 602. As shown, a second end 620 of the tube 616 is coupled to the third inlet 609 to provide the steam to the mixing and cooling zone 610.

As a result, the chamber 602 generates a third gas stream (including second synthesis gas) based on the first gas stream, the second gas stream, and the steam using the steam reforming. As shown, the chamber 602 includes an outlet 624 to output the third gas stream (including the second synthesis gas) generated by the integrated reformer 500A, B.

As shown, in some implementations, the reaction zone 604, which may include catalyst 626, is disposed between the outlet 624 and the first inlet 606 so the mixture of the first gas stream, the second gas steam, and the steam from the cooling unit 514 can efficiently pass through the reaction zone 604 that promotes more reactions for synthesis gas production. Similar reasons, when the reaction zone 604 includes the catalyst 626, the mixture of the first gas stream, the second gas stream and the steam can efficiently pass through the catalyst 626 that promotes more reactions for synthesis gas production (e.g., catalytic process).

As shown, in some implementations, the catalyst 626 includes a porous material or structure (e.g., mesh, plurality of tubes or pipes, membrane).

Modifications, additions, or omissions may be made to the integrated reformer 600A without departing from the scope of the present disclosure. For example, the coolant in the cooling unit 614 is only used for cooling the first gas stream and steam from the heat utilization unit (as discussed above) is used for the steam reforming process. In this case, the coolant, after cooling the mixture of the first gas stream, may be re-used by the cooling unit 614 after condensing.

FIG. 6B illustrates a cross-sectional view of an example integrated reformer 600B in accordance with some implementations of this disclosure.

As shown, the integrated reformer 600B is substantially similar to the integrated reformer 600A in FIG. 6A. Therefore duplicated detail description is not repeated here.

As shown, in some implementations, the third inlet 609 is in fluid communication with a heat utilization unit 640. In some implementation, in addition to the coolant (e.g., steam) from the cooling device 614, steam from the heat utilization unit 640 is provided to the chamber 602 to generate the third gas stream. In some implementation, in alternative to the coolant from the cooling device 614, the steam from the heat utilization unit 640 is provided to the chamber 602 to generate the third gas stream.

In some implementations, the coolant in the cooling unit 614 is only used for cooling the first gas stream and steam from the heat utilization unit 640 is used for the steam reforming process. In this case, the coolant, after cooling the mixture of the first gas stream, may be re-used by the cooling unit 614 after condensing.

In some implementations, the coolant includes water. In some implementations, the coolant includes CO₂. In some implementations, the coolant includes CH₄. In some implementations, the coolant includes oil.

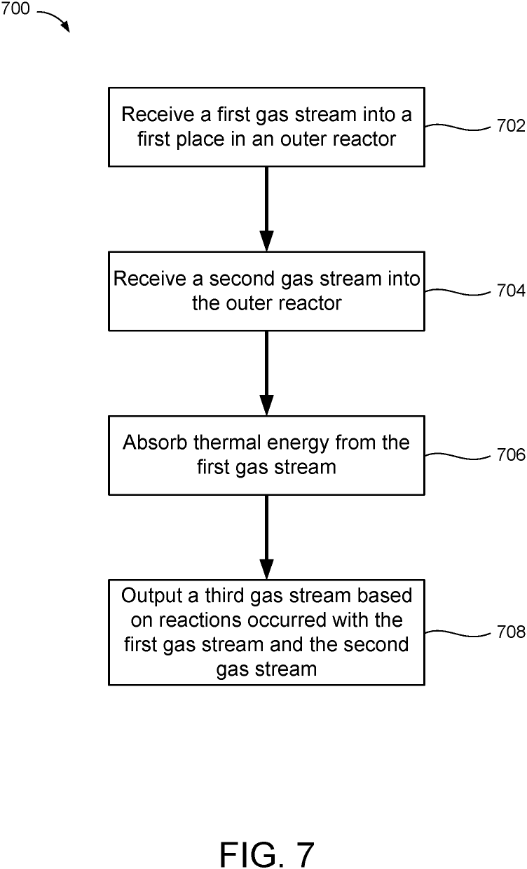

FIG. 7 illustrates a flowchart for an example method 700 for plasma carbon conversion unit in accordance with some implementation of this disclosure. The method 700 may be performed by any component, including the plasma carbon conversion unit 102, integrated reformer 120, or any other component, or subcomponent. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Although illustrated as discrete blocks, various blocks may be divided into additional blocks, combined into fewer blocks, or eliminated, depending on the desired implementation.

The method 700, at operation 702, includes receiving, from a plasma reactor, a first gas stream into an outer chamber. At operation 704, the method includes receiving a second gas stream into the outer chamber, where the second gas stream may include a coolant, such as water/steam. At operation 706, the method includes absorbing, by a cooling unit, thermal energy from the first gas stream. At operation 708, the method includes outputting a third gas stream based on reactions occurred with the first gas stream and the second gas stream.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A device, comprising:
an outer chamber;
a first inlet configured to obtain a first gas stream into a first space in the outer chamber;
a second inlet configured to obtain a second gas stream into the first space in the outer chamber; and
a cooling unit associated with the outer chamber,
wherein the cooling unit is configured to absorb thermal energy from the first gas stream.

2. The device of claim 1, wherein the cooling unit is disposed adjacent to the first inlet.

3. The device of claim 1, wherein the cooling unit is configured to receive coolant, the coolant including at least one of: H₂O, oil, CO₂, or CH₄.

4. The device of claim 1, wherein the cooling unit includes a tube disposed around the outer chamber.

5. The device of claim 4, wherein:
the tube includes a coolant inlet configured to receive coolant, and
the tube includes a coolant outlet configured to output the coolant that absorbed the thermal energy from the first gas stream.

6. The device of claim 5, wherein:
the coolant received by the coolant inlet includes H₂O in a liquid state, and
the coolant from the coolant outlet includes H₂O in a gas state.

7. The device of claim 5, wherein:
the coolant from the coolant outlet is provided to the first space in the outer chamber.

8. The device of claim 5, further comprising:
a reaction chamber in the outer chamber,
wherein the coolant from the coolant outlet, the first gas stream, and the second gas stream are provided to a second space in the reaction chamber.

9. The device of claim 8, further comprising:
a catalyst in the reaction chamber,
wherein the coolant from the coolant outlet, the first gas stream, and the second gas stream pass through the catalyst.

10. The device of claim 9, wherein the catalyst includes a porous material.

11. The device of claim 8, further comprising:
an outlet configured to output a third gas stream from the reaction chamber,
wherein the third gas stream is based on reactions occurred with the first gas stream, the second gas stream, and the coolant from the coolant outlet.

12. The device of claim 11, wherein:
the first gas stream includes first synthesis gas,
the second gas stream includes hydrocarbon fuel, and
the third gas stream includes third synthesis gas.

13. The device of claim 12, wherein the hydrocarbon fuel includes at least one of biogas, natural gas, or CH₄.

14. The device of claim 12, wherein the hydrocarbon fuel is pre-heated prior to the outer chamber.

15. The device of claim 7, further comprising:
an outlet,
wherein the outlet outputs a third gas stream based on reactions occurred with the first gas stream, the second gas stream, and the coolant from the coolant outlet.

16. The device of claim 15, further comprising:
a catalyst between the first inlet and the outlet.

17. The device of claim 15, wherein:
the first gas stream includes first synthesis gas,
the second gas stream includes hydrocarbon fuel, and
the third gas stream includes second synthesis gas.

18. The device of claim 17, wherein the hydrocarbon fuel includes at least one of biogas, natural gas, or CH₄.

19. The device of claim 17, wherein the hydrocarbon fuel is pre-heated prior to the outer chamber.

20. The device of claim 5, wherein:
steam from a steam generating unit is provided to the first space in the outer chamber.

21. The device of claim 20, further comprising:
an outlet,
wherein the outlet outputs a third gas stream based on reactions occurred with the first gas stream, the second gas stream, and the steam from the steam generating unit.

22. The device of claim 5, further comprising:
a reaction chamber in the outer chamber,
wherein steam from a steam generating unit, the first gas stream, and the second gas stream are provided to a second space in the reaction chamber.

23. The device of claim 21, further comprising:
an outlet,
wherein the outlet outputs a third gas stream based on reactions occurred with the first gas stream, the second gas stream, and the steam.

24. The device of claim 1, wherein the device includes an integrated reformer that is included with a plasma carbon conversion unit (PCCU), the PCCU including a plasma reactor in fluid communication with the integrated reformer.

25. A method for plasma carbon conversion, the method comprising:
receiving, from a plasma reactor, a first gas stream into an outer chamber;
receiving a second gas stream into the outer chamber; and
absorbing, by a cooling unit, thermal energy from the first gas stream.

26. The method of claim 25, wherein the first gas stream is received at a first inlet, wherein the second gas stream is received at a second inlet.

27. The method of claim 25 further comprising providing the first gas stream, the second gas stream, and a coolant to a reaction chamber in the outer chamber.

28. The method of claim 25, wherein:
the first gas stream includes first synthesis gas, and
the second gas stream includes hydrocarbon fuel.

29. The method of claim 25, wherein the second gas stream is pre-heated prior to the outer chamber.

30. The method of claim 25, wherein steam from a steam generating unit is received at the outer chamber.

31. The method of claim 25, further comprising outputting a third gas stream based on reactions occurred with the first gas stream and the second gas stream.
